(19) United States
(12) Patent Application Publication
(10) Pub. No.: US 2012/0237033 A1
(43) Pub. Date: Sep. 20, 2012

(54) NODE, A ROOT NODE, AND A COMPUTER READABLE MEDIUM

(76) Inventors: Yasuyuki TANAKA, Kanagawa-ken (JP); Yoshihiro OBA, Kanagawa-ken (JP); Shinji YAMANAKA, Tokyo (JP)

(21) Appl. No.: 13/233,186

(22) Filed: Sep. 15, 2011

(30) Foreign Application Priority Data
Mar. 16, 2011 (JP) P2011-058318

(51) Int. Cl. H04W 12/06; H04W 12/04

(52) U.S. Cl. 380/270

(57) ABSTRACT

According to one embodiment, a wireless mesh network includes a plurality of nodes of which one is a root node and two nodes hierarchically adjacent have a parent-child relationship. In a node in the wireless mesh network, an authentication processing unit executes an authentication for network access with the root node when the node joins in the wireless mesh network. A root key setting unit generates a root key as a common key between the root node and the node. A parent-child key setting unit generates a parent-child key as a common key between a parent node and the node, encrypts the parent-child key using the root key, and sends the parent-child key encrypted to the root node. A group key acquisition unit receives a group key encrypted using the parent-child key from the parent node, and decrypts the group key using the parent-child key.

### CROSS-REFERENCE TO RELATED APPLICATION

This application is based upon and claims the benefit of priority from Japanese Patent Application No. 2011-058318, filed on Mar. 16, 2011; the entire contents of which are incorporated herein by reference.

### FIELD

Embodiments described herein relate generally to a node, a root node, and a computer readable medium for causing a computer to perform a method for controlling the node.

### BACKGROUND

Usually, a wireless mesh network forms a rooting topology of a tree shape by a plurality of nodes having one root node and a parent-child relationship between two nodes hierarchically adjacent. In the wireless mesh network, technique to share one group key among each node is known.

For example, the group key is used for validation for each node connected to the wireless mesh network. When anode newly joins in the wireless mesh network, the node (Hereinafter, it is called new node) performs an authentication process for network access with the root network. If the authentication succeeds, the root node and the new node respectively generate a common cipher key, and share it. Then, the root node sends a group key encrypted by the cipher key to the new node. In this way, the new node can acquire the group key from the root node.

The group key has a lifetime (effective period). In this case, before the lifetime expires, a new group key is generated. The new group key needs to be shared among all nodes in the wireless mesh network.

When the root node updates the group key, in order to share the group key among nodes in the network, the root node transfers a new group key (updated group key) to each node with hop by hop. Briefly, the new group key (sent by the root node) is transmitted among nodes hierarchically adjacent in order.

In order to transmit the group key with hop by hop, a cipher key (necessary for encryption/decryption) needs to be exchanged between two nodes hierarchically adjacent, i.e., a node of transmitting side (parent node) and a node of receiving side (child node).

As a technique to exchange the cipher key, for example, usage of exchange of a public key using PKI (Public Key Infrastructure) is supposed. However, when this technique is used, in order to show that the public key is valid, authentication data issued by Certification Authority needs to be acquired. Accordingly, a processing load for key exchange in the node becomes large.

### BRIEF DESCRIPTION OF THE DRAWINGS

FIG. 1 is a block diagram of a system according to embodiments.

FIG. 2 is a sequence diagram showing operation of the system according to a first embodiment.

FIG. 3 is a block diagram of a child node according to the first embodiment.

FIG. 4 is a block diagram of a parent node according to the first embodiment.

FIG. 5 is a block diagram of a root node according to the first embodiment.

FIG. 6 is a sequence diagram showing operation of the system according to a second embodiment.

FIG. 7 is a block diagram of a child node according to the second embodiment.

FIG. 8 is a block diagram of a parent node according to the second embodiment.

FIG. 9 is a block diagram of a root node according to the second embodiment.

FIG. 10 is a sequence diagram showing operation of the system according to a third embodiment.

FIG. 11 is a block diagram of a child node according to the third embodiment.

FIG. 12 is a block diagram of a parent node according to the third embodiment.

FIG. 13 is a block diagram of a root node according to the third embodiment.

FIG. 14 is a sequence diagram showing operation of the system according to a fourth embodiment.

FIG. 15 is a block diagram of a child node according to the fourth embodiment.

FIG. 16 is a block diagram of a parent node according to the fourth embodiment.

FIG. 17 is a block diagram of a root node according to the fourth embodiment.

FIG. 18 is a sequence diagram showing operation of the system according to a fifth embodiment.

FIG. 19 is a block diagram of a child node according to the fifth embodiment.

FIG. 20 is a block diagram of a parent node according to the fifth embodiment.

### DETAILED DESCRIPTION

According to one embodiment, a wireless mesh network includes a plurality of nodes of which one is a root node and two nodes hierarchically adjacent have a parent-child relationship. A node in the wireless mesh network includes an authentication processing unit, a root key setting unit, a parent-child key setting unit, and a group key acquisition unit. The authentication processing unit is configured to execute an authentication for network access with the root node when the node joins in the wireless mesh network. The root key setting unit is configured to generate a root key as a common key between the root node and the node. The parent-child key setting unit is configured to generate a parent-child key as a common key between a parent node and the node, to encrypt the parent-child key using the root key, and to send the parent-child key encrypted to the root node. The parent node and the node have the parent-child relationship. The group key acquisition unit is configured to receive a group key encrypted using the parent-child key from the parent node, and to decrypt the group key using the parent-child key.

Various embodiments will be described hereinafter with reference to the accompanying drawings.

### The First Embodiment

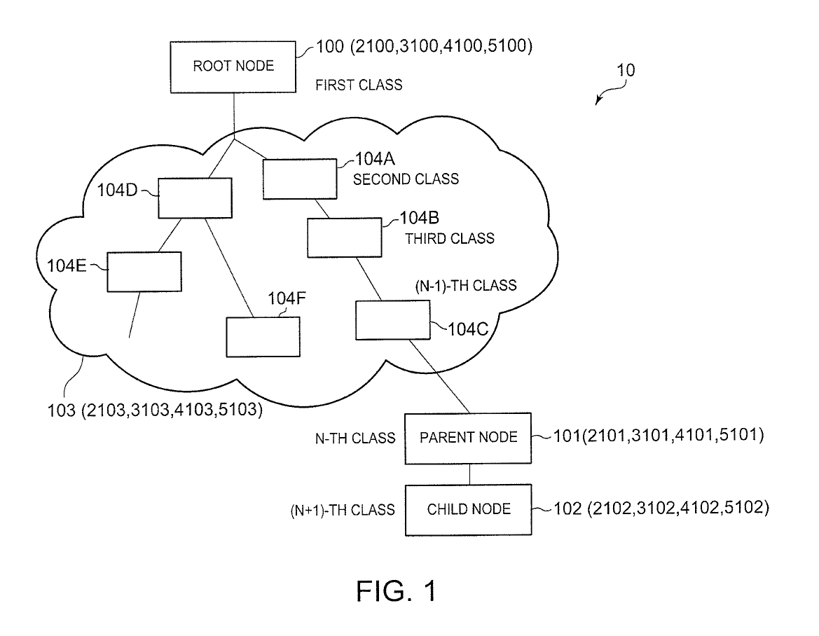

FIG. 1 is a block diagram of a system 10 according to the first embodiment. The system 10 is a wireless mesh network 10 forming a rooting topology. The rooting topology has a tree structure by a plurality of nodes including one root node and a parent-child relationship between two nodes hierarchically adjacent. In the system 10, if a root node 100 is the first class, a node of the lowest class is the (N+1)-th class.

The system 10 includes the root node 100, a parent node 101, a child node 102, and a network 103. In the wireless mesh network 10, one root node 100 exists. The root node 100 is a node of the highest class (the first class). The root node 100 controls each node in the wireless mesh network 10. Furthermore, the root node 100 controls group keys shared among each node in the wireless mesh network 10. Moreover, the group key is explained afterwards.

Control of the node by the root node 100 is, for example, permission/prohibition for the node to join in the wireless mesh network 10, detection for the node to leave from the wireless mesh network 10, and update of a database of nodes in the wireless mesh network 10. Furthermore, control of the group key is, for example, generation of the group key, monitor of a lifetime of the group key, and generation of a new group key.

A network 103 includes nodes from the second class to the (N−1)-th class in the system 10. In FIG. 1, nodes 104A and 104D are nodes of the second class, nodes 104B and 104E are nodes of the third class, and nodes 104C and 104F are nodes of the (N−1)-th class.

The parent node 101 is a node of the N-th class in the system 10. The parent node 101 connects a node 1040 in the network 103. The parent node 101G receives data (addressed to a child node 102) from the node 104C, and transfers the data to the child node 102.

The child node 102 performs sending/receiving of data with the parent node 101. The child node 102 is a node of the lowest class (the (N+1)-th class) in the system 10.

In general, the parent node and the child node are guided from correlative positional relationship on a rooting tree. In two nodes hierarchically adjacent, a node of a higher class is the parent node, and a node of a lower class is the child node. Briefly, the parent node 101 is a parent node for the child node 102, but a child node for a node 104C.

In the first embodiment, in order to simplify the explanation, as shown in FIG. 1, a node of the lowest class (the (N+1)-th class) in the system 10 is the child node, and a node of one class higher (the N-th class) than the lowest class is the parent class.

Next, a group key is explained. For example, the group key is used for encryption of data in the wireless mesh network 10. The group key is information shared among all nodes in the wireless mesh network 10. Briefly, the group key is a common key for each node in the wireless mesh network 10. As to encryption/decryption using the group key, a common key cryptosystem is used.

Next, a method for all nodes in the wireless mesh network 10 to share the group key is explained. First, a method for a node newly joining in the wireless mesh network 10 to acquire the group key is explained.

When a node newly joins in the wireless mesh network, a root node notifies a group key to the node newly joining (Hereinafter, it is called a new node). When the root node notifies the group key to the new node, the group key is encrypted and notified. Because this encryption prevents leakage of the group key outside the wireless mesh network. As a cipher key used for this encryption, a cipher key shared between the root node and the new node is used. This cipher key is generated at a time of authentication for network access to be performed when the new node joins in the wireless mesh network. Detail of the authentication for network access is explained afterwards.

The group key has a lifetime. Accordingly, the root node needs to update the group key (being used) before expiring the lifetime, and send a new group key (after updating) to each node in the wireless mesh network. Because it is maintained that each node in the wireless mesh network always preserves an effective group key. A message including the new group key (after updating) also needs to be notified with encryption. Because this encryption prevents leakage of the group key outside the wireless mesh network.

One method for notifying a new group key (updated) is explained. The new group key (sent by the root node) is sent from a parent node to a child node by unicast in order. The parent node and the child node have a parent-child relationship. As a result, the new group key is transferred from the root node to all nodes in the wireless mesh network with hop by hop.

In this method, the new group key (updated) needs to be encrypted by the parent node and decrypted by the child node. Because this encryption/decryption prevents leakage of the new group key outside the wireless mesh network and the new group key needs to be transferred from the parent node to the child node in order. In order to realize encryption by the parent node and decryption by the child node, a cipher key and decipher key need to be changed between the parent node and the child node.

In the first embodiment, between the parent node and the child node, at timing before updating the group key, the cipher key and the decipher key can be exchanged effectively and safely. Moreover, in the first embodiment, as a method for encryption/decryption, an example using a common key cryptosystem is explained. In the common key cryptosystem, the same key is used for encryption and decryption.

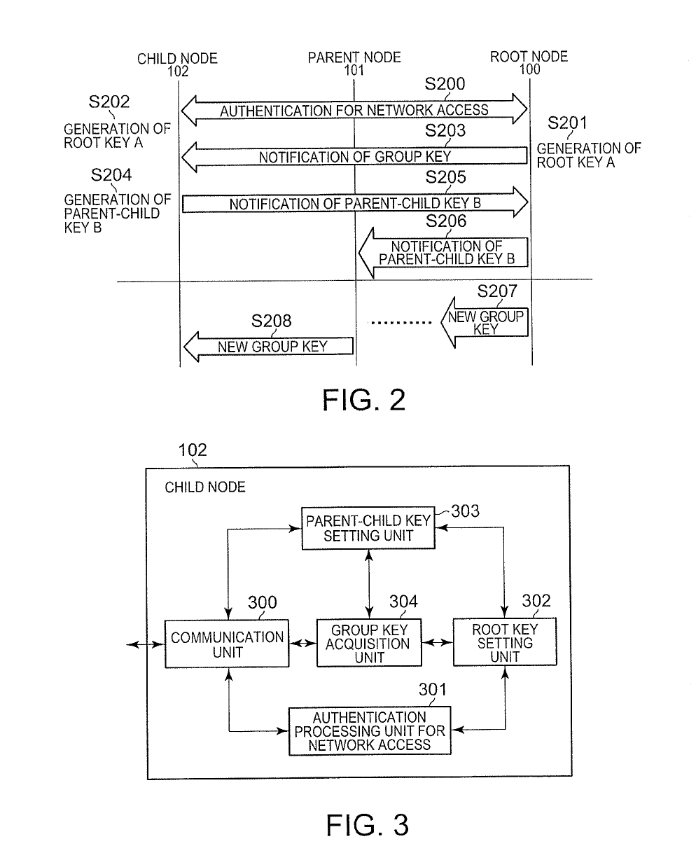

Hereinafter, between the parent node and the child node, an example to realize a method for sharing the common key is explained. FIG. 2 is a sequence diagram showing operation of the system in FIG. 1.

Hereinafter, a case that a child node 102 newly joins in the wireless mesh network is explained as one example. First, a method for sharing a common key between the parent node 101 and the child node 102 is explained.

When the child node newly joins in the wireless mesh network, the child node 102 performs authentication for network access with a root node 100 via a parent node 101 (S200). If the root node 100 succeeds in authentication of the child node 102, the child node 102 receives a notification of authentication-success from the root node 100.

After receiving the notification of authentication-success, the child node 102 generates a root key A by using the authentication result (S200). Furthermore, with notifying the authentication-success to the child node 102, the root node 100 generates a root key A by using the authentication result in the same way as the child node 102 (S201). As a result, the root key A is shared between the root node 100 and the child node 102.

Next, the root node 100 encrypts a group key (managed by the root node 100) using the root key A, and sends an encrypted group key to the child node 102. The child node 102 receives a notification of the encrypted group key (S203). The child node decrypts the encrypted group key using the root key A, and acquires the group key.

Next, the child node 102 generates a common key (Hereinafter, it is called a parent-child key B) shared with the parent node (S204). The child node 102 encrypts the parent-child key B using the root key A, and notifies an encrypted parent-child key B to the root node 100 (S205). The root node 100 receives the encrypted parent-child key B, and decrypts it using the root key A.

Next, the root node 100 encrypts the parent-child key B using a root key C, and sends an encrypted parent-child key B to the parent node 102 (S206). In this case, the root key C is a common key shared between the root node 100 and the parent node 102. When the parent node 102 has joined in the wireless mesh network, the root key C was shared between the parent node 102 and the root node 100. A method for generating/sharing the root key C is same as a method for generating/sharing the root key A between the child node 102 and the root node 100 as above-mentioned.

When the parent node 102 receives the encrypted parent-child key B, the parent node 102 decrypts the encrypted parent-child key B using the root key C, and acquires the parent-child key B. By above-mentioned steps, the parent-child key B as the common key can be shared between the parent node 101 and the child node 102.

Next, as to a new group key (updated) notified by the root node 100, steps to transfer the group key to the parent node 101 and the child node 102 are explained.

After generating a group key, the root node 100 sends a new group key with encryption (S207). This new group key is transferred to the parent node 101 via the network 103. After acquiring the new group key, the parent node 101 encrypts the new group key using the parent-child key B, and sends an encrypted new group key to the child node 102. After receiving the encrypted new group key, the child node 102 decrypts the encrypted new group key using the parent-child key B, and acquires the new group key.

In above-mentioned operation, processing among the root node 100, the parent node 101 and the child node 102 shown in FIG. 1 is explained. However, as to above-mentioned operation, the same processing is performed between a parent node and a child node in the network 103 not shown in FIG. 1. Briefly, a common key is shared between the parent node and the child node in the network 103. Then, as to a new group key sent by the root node 100, the parent node encrypts the new group key, and the child node decrypts an encrypted new group key. By repeating this processing, the new group key can be transferred from the parent node to the child node in order.

By above-mentioned operation, all nodes in the wireless mesh network (controlled by the root node) can share the updated group key safely and effectively.

FIG. 3 is a block diagram of the child node 102. A communication unit 300 connects the parent node 101. The communication unit 300 communicates with the parent node 101. Furthermore, the communication unit 300 communicates with the root node 100 via the parent node 101.

An authentication processing unit for network access 301 (Hereinafter, it is called an authentication processing unit 301) performs an authentication processing for network access with the root node 100 via the communication unit 300. A root key setting unit 302 generates a root key A using an authentication result of the authentication processing for network access. The authentication result is received from the authentication processing unit 301.

A parent-child key setting unit 303 generates a parent-child key B. Furthermore, the parent-child key setting unit 303 encrypts the parent-child key B using the root key A. The parent-child key setting unit 303 sends an encrypted parent-child key B to the root node 100 via the communication unit 300.

When the child node 102 connects the wireless mesh network (including the root node 100), a group key acquisition unit 304 acquires a group key (encrypted using the root key A) from the root node 100 via the communication unit 300. After acquiring the encrypted group key, the group key acquisition unit 304 decrypts the encrypted group key using the root key A, and acquires the group key. Furthermore, the group key acquisition unit 304 receives a new group key (encrypted using the parent-child key B) from the parent node 101 via the communication unit 300. The group key acquisition unit 304 decrypts the encrypted new group key using the parent-child key B. Moreover, this parent-child key B is acquired from the parent-child key setting unit 303.

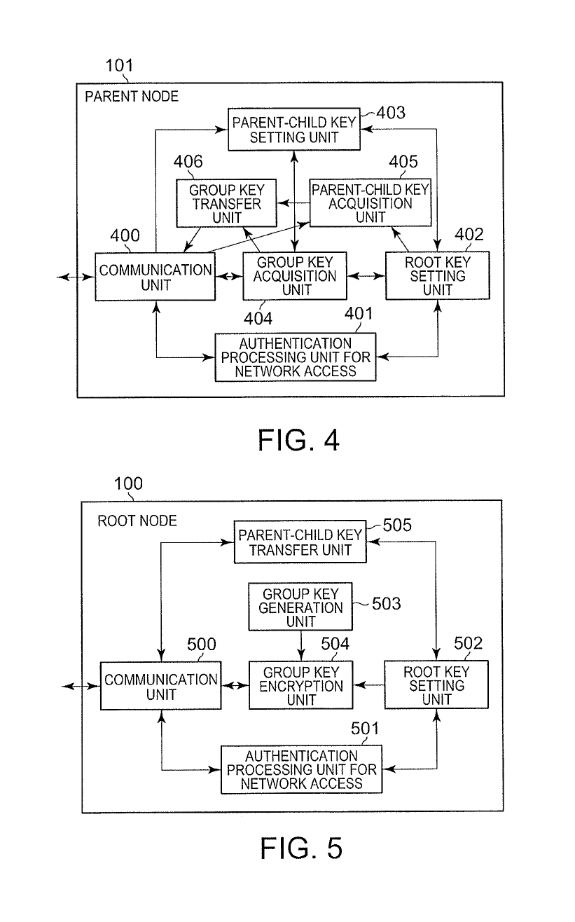

FIG. 4 is a block diagram of the parent node 101 according to the first embodiment. As mentioned-above, the parent node 101 has the same component and function as the child node.

A communication unit 400 communicates with the child node 100. Furthermore, the communication unit 400 communicates a node 104C as a parent node of the parent node 101. Furthermore, the communication unit 400 communicates the root node 100 via the node 104C (parent node).

An authentication processing unit 401 (for network access) performs an authentication processing for network access with the root node 100 via the communication unit 400.

A root key setting unit 402 generates a root key C using an authentication result of the authentication processing for network access. The authentication result is received from the authentication processing unit 401.

A parent-child key setting unit 403 generates a parent-child key D. Furthermore, the parent-child key setting unit 403 encrypts the parent-child key D using the root key C. The parent-child key setting unit 403 sends an encrypted parent-child key D to the root node 100 via the communication unit 400.

When the parent node 101 connects the wireless mesh network (including the root node 100), a group key acquisition unit 404 acquires a group key (encrypted using the root key C) from the root node 100 via the communication unit 400. After acquiring the encrypted group key, the group key acquisition unit 404 decrypts the encrypted group key using the root key C, and acquires the group key. Furthermore, the group key acquisition unit 404 receives a new group key (encrypted using the parent-child key D) from the node 104C via the communication unit 400. The group key acquisition unit 404 decrypts the encrypted new group key using the parent-child key D.

Following component is included in not the child node 102 but the parent node 101. A parent-child key acquisition unit 405 receives a parent-child key B (sent by the child node 102) via the root node 100. When the child node 102 sends the parent-child key B to the root node 100, the parent-child key B was already encrypted using the root key A. The parent-child key B is decrypted by the root node 100. Then, the parent-child key B encrypted (using the root key C) by the root node 100 is received. After receiving an encrypted parent-child key B, the parent-child key acquisition unit 405 decrypts the encrypted parent-child key B using the root key C, and acquires the parent-child key B.

A group key transfer unit 406 encrypts a new group key (acquired by the group key acquisition unit 404) using the parent-child key B, and sends an encrypted new group key to the child node 102 via the communication unit 400.

FIG. 5 is a block diagram of the root node 100 according to the first embodiment. A communication unit 500 communicates with each node in the wireless mesh network.

An authentication processing unit 501 (for network access) performs an authentication processing for network access with a node newly joining in the wireless mesh network, via the communication unit 500. When the authentication processing succeeds, the authentication processing unit 501 sends a notification representing that the authentication processing succeeds to the node.

A root key setting unit 502 generates a root key using an authentication result of the authentication processing for network access. As to each node joining in the wireless mesh network, the root key setting unit 502 generates a different root key.

A group key generation unit 503 generates a group key. For example, by monitoring a lifetime (effective period) of the group key, before the lifetime of the group key expires, the group key generation unit 503 updates the group key, and generates a new group key.

A group key encryption unit 504 encrypts the group key, and notifies an encrypted group key to each node in the wireless mesh network, via the communication unit 500. When the group key is notified to a node newly joining in the wireless mesh network, the group key encryption unit 502 encrypts the group key using a root key, which was generated using a result of authentication for network access with this node. On the other hand, when a new group key (updated group key) is sent to all nodes in the wireless mesh network at a time when the group key is updated, the group key encryption unit 504 encrypts the new group key using a root key, which was generated using a result of authentication for network access with a child node (node 104A, node 104D in FIG. 1) of the root node.

A parent-child key transfer unit 505 receives a parent-child key B (encrypted by the child node 102) from the child node 102 via the communication unit 500, and decrypts the parent-child key B using the root key A. The parent-child key transfer unit 505 encrypts the parent-child key B using the root key C, and notifies an encrypted parent-child key B to the parent node 101 via the communication unit 500.

Furthermore, for example, the child node 102 can be realized by using a general purpose computer as a basic hardware. Briefly, the communication unit 300, the authentication processing unit 301, the root key setting unit 302, the parent-child key setting unit 303, and the group key acquisition unit 304, can be realized by making a processor (loaded onto above-mentioned computer) execute a program. In this case, the child node 102 may be realized by previously installing this program into the computer. Alternatively, by storing this program into a storage medium such as CD-ROM, or by distributing this program via the network, i.e., by suitably installing this program into the computer, the child node 102 may be realized.

Furthermore, for example, the parent node 101 can be realized by using a general purpose computer as a basic hardware. Briefly, the communication unit 400, the authentication processing unit 401, the root key setting unit 402, the parent-child key setting unit 403, the group key acquisition unit 404, the parent-child key acquisition unit 405, and the group key transfer unit 406, can be realized by making a processor (loaded onto above-mentioned computer) execute a program. In this case, the parent node 101 may be realized by previously installing this program into the computer. Alternatively, by storing this program into a storage medium such as CD-ROM, or by distributing this program via the network, i.e., by suitably installing this program into the computer, the parent node 101 may be realized.

Furthermore, for example, the root node 100 can be realized by using a general purpose computer as a basic hardware. Briefly, the communication unit 500, the authentication processing unit 501, the root key setting unit 502, the parent-child key generation unit 503, the group key encryption unit 504, and the parent-child key transfer unit 505, can be realized by making a processor (loaded onto above-mentioned computer) execute a program. In this case, the root node 100 may be realized by previously installing this program into the computer. Alternatively, by storing this program into a storage medium such as CD-ROM, or by distributing this program via the network, i.e., by suitably installing this program into the computer, the root node 100 may be realized.

### The Second Embodiment

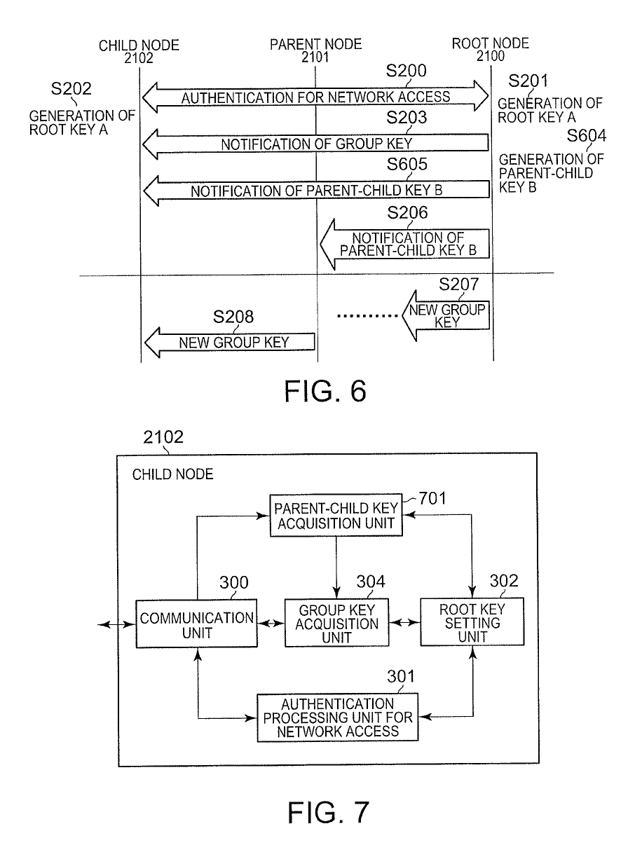

FIG. 6 is a sequence diagram showing operation of a system according to the second embodiment. As shown in FIG. 6, in the system of the second embodiment, a root node 2100 generates a parent-child key B, and notifies the parent-child key B to a parent node 2101 and a child node 2102 respectively. This feature is different from the system of the first embodiment.

The system of the second embodiment is shown in FIG. 1. The system of the second embodiment includes a root node 2100, a network 2103, a parent node 2101 and a child node 2102. A connection relationship among each node 2100, 2101, 2102, and the network 2103, is same as the system of the first embodiment. Furthermore, a connection relationship among nodes in the network 2103 is same as the system of the first embodiment.

Next, operation of the system of the second embodiment is explained. Processing from S200 to S203 is same as that of the first embodiment.

After operating S203, the root node 2100 generates a parent-child key B (S604). Next, the root node 2100 encrypts the parent-child key B using a root key A, and notifies an encrypted parent-child key B to the child node 2102 (S605). Furthermore, the root node 2100 encrypts the parent-child key B using a root key C, and notifies an encrypted parent-child key B to the parent node 2101 (S606). In this case, the root key A is shared between the root node 2100 and the child node 2102 after the child node 2102 has joined in the wires mesh network. The root key C is shared between the root node 2100 and the parent node 2101 after the parent node 2101 has joined in the wires mesh network. A method for generating the root key A and the root key C are same as that explained in the first embodiment.

After the child node 2102 receives the encrypted parent-child key B, the child node 2102 decrypts the encrypted parent-child key B using the root key A, and acquires the parent-child key B. After the parent node 2101 receives the encrypted parent-child key B, the parent node 2101 decrypts the encrypted parent-child key B using the root key C, and acquires the parent-child key B. By this operation, the parent-child key B as a common key can be shared between the parent node 2101 and the child node 2102.

Operation after this processing, i.e., steps to transfer the updated group key (notified by the root node 2100) to the parent node 2101 and the child node 2102 are same as S207 and S208 of the method explained in the first embodiment. Moreover, as to above-mentioned operation, same processing is executed in a node not shown in FIG. 1, as explained in the first embodiment.

By above-mentioned steps, when the parent-child key B is shared between the parent node 2101 and the child node 2102, processing load can be lowered. Furthermore, all nodes in the wireless mesh network (controlled by the root node 2100) can share the updated group key safely and effectively.

FIG. 7 is a block diagram of the child node 2102 according to the second embodiment. The child node 2102 does not include the parent-child key setting unit 303, which is included in the child node 102. However, the child node 2102 includes a parent-child key acquisition unit 701, which is not included in the child node 102. The parent-child key acquisition unit 701 receives an encrypted parent-child key B (sent by the root node 2100). Then, the parent-child key acquisition unit 701 decrypts the encrypted parent-child key B using the root key A.

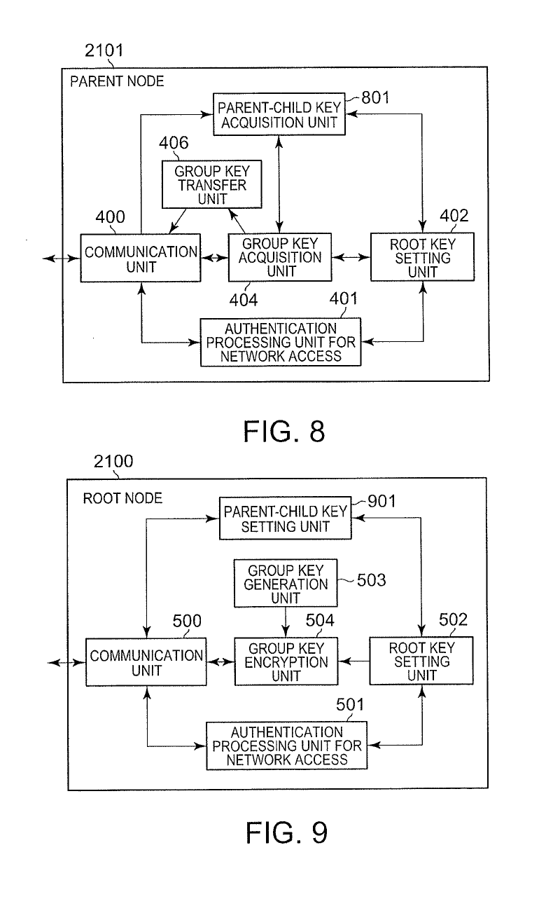

FIG. 8 is a block diagram of the parent node 2101 according to the second embodiment. The parent node 2101 has a function of the child node 2102. Accordingly, feature which the parent node 2101 includes a component and a function of the child node 2102 is same as that of the first embodiment.

The parent node 2101 does not include the parent-child key setting unit 403 and the parent-child key acquisition unit 405, which are included in the parent node 101. However, the parent node 2101 includes a parent-child key acquisition unit 805, which is not included in the parent node 101. The parent-child key acquisition unit 801 receives an encrypted parent-child key B (sent by the root node 2100). Then, the parent-child key acquisition unit 801 decrypts the encrypted parent-child key B using the root key C.

FIG. 9 is a block diagram of the root node 2100 according to the second embodiment. The root node 2100 does not include the parent-child key transfer unit 505, which is included in the root node 100. However, the root node 2100 includes a parent-child key setting unit 901, which is not included in the root node 100.

The parent-child key setting unit 901 generates a parent-child key B. Furthermore, the parent-child key setting unit 901 encrypts the parent-child key B using the root key A, and sends an encrypted parent-child key B to the child node 2102. Furthermore, the parent-child key setting unit 901 encrypts the parent-child key B using the root key C, and sends an encrypted parent-child key B to the parent node 2101.

### The Third Embodiment

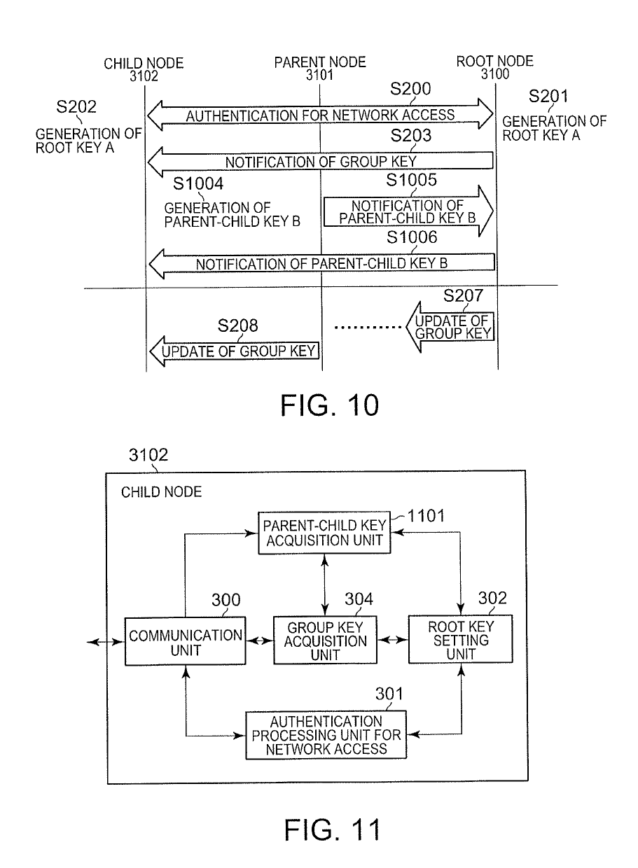

FIG. 10 is a sequence diagram showing operation of a system according to the third embodiment. As shown in FIG. 3, in the system of the third embodiment, a parent node 3101 generates a parent-child key B, and notifies the parent-child key B to a child node 3102 via a root node 3100. This feature is different from the first embodiment.

The system of the third embodiment is shown in FIG. 1. The system of the third embodiment includes a root node 3100, a network 3103, a parent node 3101 and a child node 3102. A connection relationship among each node 3100, 3101, 3102, and the network 3103, is same as the system of the first embodiment. Furthermore, a connection relationship among nodes in the network 3103 is same as the system of the first embodiment.

Next, operation of the system of the third embodiment is explained. Processing from S200 to S203 is same as that of the first embodiment.

The parent node 3101 recognizes an authentication for network access (S200) between the root node 3100 and the child node 3102, and a message of notification (S203) of a group key from the root node 3100 to the child node 3102. By this recognition, the parent node 3101 detects that the authentication of the child node 3102 succeeds and the child node 3102 acquires the group key. When the parent node 3101 detects success of the authentication of the child node 3102 or a notification of the group key from the root node 3100 to the child node 3102, the parent node 3101 generates a parent-child key B (S1004), encrypts the parent-child key B using a root key C, and notifies an encrypted parent-child key B to the root node (S1005).

When the root node 3100 receives the encrypted parent-child key B, the root node 3100 decrypts the encrypted parent-child key B using the root key C. Next, root node 310 encrypts the parent-child key B using a root key A, and sends an encrypted parent-child key B to the child node 3102 (S1006). Moreover, a method for sharing the root key A between the child node 3102 and the root node 3100, and a method for sharing the root key C between the parent node 3101 and the root node 3100, are same as those explained in the first embodiment.

After the child node 3102 receives the encrypted parent-child key B, the child node 3102 decrypts the encrypted parent-child key B using the root key A, and acquires the parent-child key B. By this operation, the parent-child key B as a common key can be shared between the parent node 3101 and the child node 3102.

Operation after this processing, i.e., steps to transfer the updated group key (notified by the root node 3100) to the parent node 3101 and the child node 3102 are same as S207 and S208 of the method explained in the first embodiment. Moreover, as to above-mentioned operation, same processing is executed in a node not shown in FIG. 1, as explained in the first embodiment.

By above-mentioned steps, when the parent-child key B is shared between the parent node 3101 and the child node 3102, processing load can be lowered. Furthermore, all nodes in the wireless mesh network (controlled by the root node 3100) can share the updated group key safely and effectively.

FIG. 11 is a block diagram of the child node 3102 according to the third embodiment. The child node 3102 does not include the parent-child key setting unit 303, which is included in the child node 102. However, the child node 3102 includes a parent-child key acquisition unit 1101, which is not included in the child node 102. The parent-child key acquisition unit 1101 receives an encrypted parent-child key B (sent by the parent node 3101 via the root node 3100). Then, the parent-child key acquisition unit 1101 decrypts the encrypted parent-child key B using the root key A.

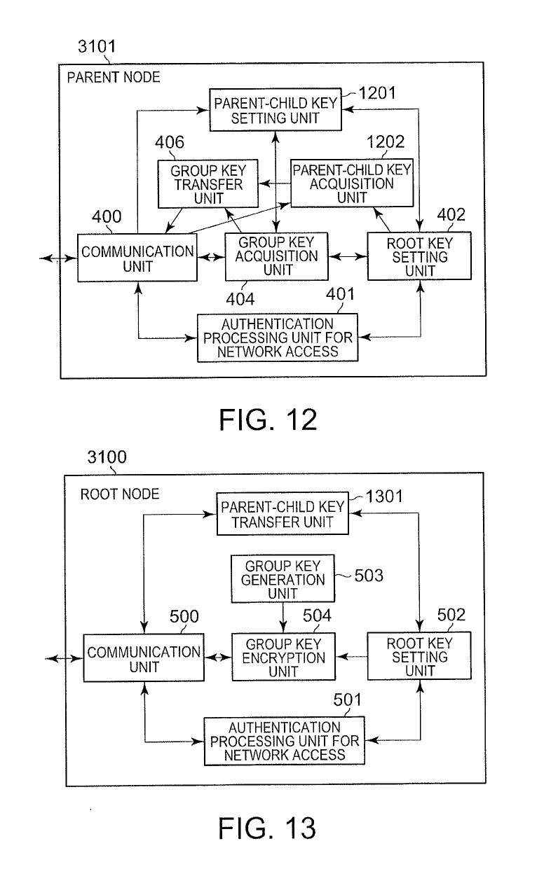

FIG. 12 is a block diagram of the parent node 3101 according to the third embodiment. The parent node 3101 has a function of the child node 3102. Accordingly, feature which the parent node 3101 includes a component and a function of the child node 3102 is same as that of the first embodiment.

The parent node 3101 does not include the parent-child key setting unit 403 and the parent-child key acquisition unit 405, which are included in the parent node 101. However, the parent node 3101 includes a parent-child key setting unit 1201 and a parent key acquisition unit 1202, which are not included in the parent node 101. The parent-child key acquisition unit 1202 is a function as a child node, and the parent-child key setting unit 1201 is a function as a parent node.

The parent-child key setting unit 1201 generates a parent-child key B. Furthermore, the parent-child key setting unit 1202 encrypts the parent-child key B using a root key C, and sends an encrypted parent-child key B via the communication unit 400.

The parent-child key acquisition unit 1202 receives an encrypted parent-child key D sent by a node 104 in FIG. 1 (as a parent node of the parent node 3101) via the root node 3100. Then, the parent-child key acquisition unit 1202 decrypts the encrypted parent-child key D using the root key C.

FIG. 13 is a block diagram of the root node 3100 according to the third embodiment. The root node 3100 does not include the parent-child key transfer unit 505, which is included in the root node 100. However, the root node 3100 includes a parent-child key transfer unit 1301, which is not included in the root node 100.

The parent-child key transfer unit 1301 receives an encrypted parent-child key B (sent by the parent node 3101) via the communication unit 500, and decrypts the encrypted parent-child key B using the root key C. Furthermore, the parent-child key transfer unit 1301 encrypts the parent-child key B using the root key A, and notifies an encrypted parent-child key B to the child node 3102 via the communication unit 500.

### The Fourth Embodiment

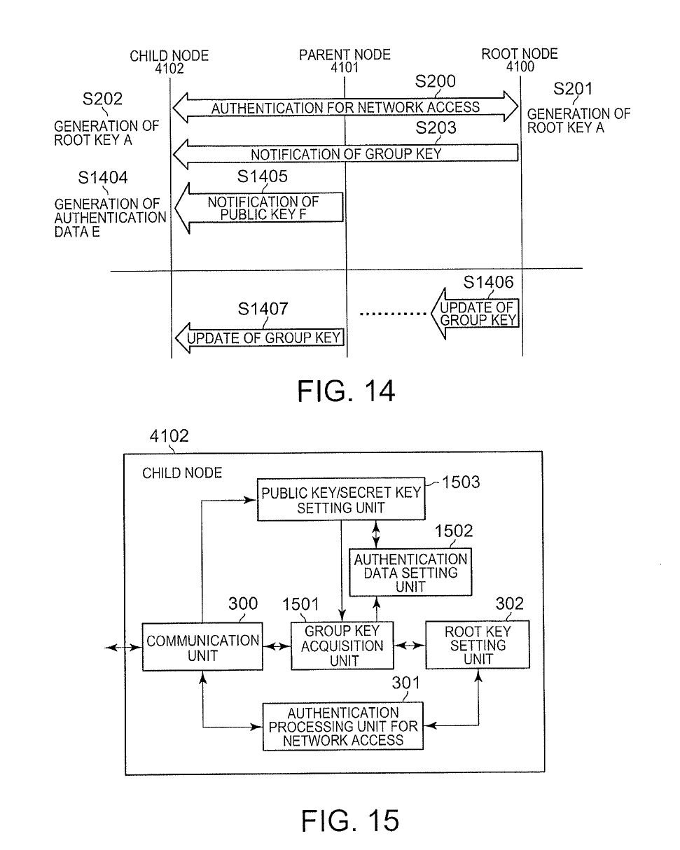

FIG. 14 is a sequence diagram showing operation of a system according to the fourth embodiment. As shown in FIG. 14, in the system of the fourth embodiment, as a method for encrypting a new group key (updated), not common key cryptosystem but public key cryptosystem is used. This feature is different from the first embodiment. Briefly, in the fourth embodiment, a child node 4102 has a secret key, and a parent node 4101 has a public key of the child node 4102. As to a group key to be sent from the parent node 4101 to the child node 4102, the parent node 4101 encrypts the group key using the public key of the child node 4102, and notifies an encrypted group key to the child node 4102. The child node 4102 decrypts the encrypted group key using the secret key.

In the fourth embodiment, when the child node 4102 notifies the public key to the parent node 4101, the child node 4102 generates authentication data (to be notified with the public key) using a group key (before updating), which is feature of this embodiment. The child node 4102 can easily generate the authentication data. After receiving the authentication data, the parent node 4101 can easily confirm the authentication data. Furthermore, the parent node 4101 can understand that the public key (notified) is a key sent from a reliable apparatus. Briefly, the parent node 4101 can understand that the public key (received) is a key sent from an apparatus having at least a group key, i.e., an apparatus joining in the wireless mesh network (controlled by the root node 4100).

Next, operation of the system of the fourth embodiment is explained. Processing from S200 to S203 is same as operation of the first embodiment.

When the child node 4102 receives a notification of a group key (S203), the child node 4102 generates authentication data E. In this case, the child node 4102 generates the authentication data E using the group key (before updating) and a public key F generated by the child node (S1404). Moreover, the child node 4102 generates a secret key G with the public key F, and has the secret key G. After generating the authentication data E, the child node 4102 notifies the public key F and the authentication data E to the parent node 4101 (S1405).

When the parent node 4101 receives the authentication data E and the public key F, the parent node 4101 calculates authentication data using a group key (maintained by the parent node 4101) and the public key F. The parent node 4101 compares the authentication data E (received from the child node 4102) to authentication data calculated by the parent node 4101. If the authentication data E is equal to the authentication data calculated, the parent node 4101 decides that the public key F is a key sent by the child node 4102, and accepts the public key F. By above-mentioned operation, the parent node 4101 can acquire the public key F of the child node 4102.

Next, an updated group key is notified from the root node 4100 to the parent node 4101 and the child node 4102. After updating a group key, the root node 4100 encrypts the updated group key, and sends an encrypted updated group key as a new group key (S1406). The new group key is transferred to the parent node 4101 via the network 103. After receiving the new group key, the parent node 4101 decrypts the new group key, and acquires the updated group key. Then, the parent node 4101 encrypts the updated group key using the public key F of the child node 4102, and sends an encrypted updated group key to the child node 4102 (S1407). After receiving the encrypted updated group key, the child node 4102 decrypts the encrypted updated group key using the secret key G corresponding to the public key F, and acquires the updated group key.

In above-mentioned operation, processing among the root node 4100, the parent node 4101 and the child node 4102, is explained. However, as to above-mentioned operation, same processing is executed for a parent node and a child node (not shown in FIG. 1) in the network 4103. Briefly, the child node in the network 4103 maintains a secret key. The parent node receives a public key corresponding to the secret key from the child node and maintains the public key. Then, as to a new group key sent by the root node 4100, the parent node encrypts the new group key, and the child node decrypts an encrypted new group key. By repeating this processing, the new group key can be transferred from the parent node to the child node in order.

By above-mentioned operation, all nodes in the wireless mesh network (controlled by the root node) can share the updated group key safely and effectively.

FIG. 15 is a block diagram of the child node 4102 according to the fourth embodiment. The child node 4102 does not include the parent-child key setting unit 303 and the group key acquisition unit 304, which are included in the child node 102. However, the child node 4102 includes a group key acquisition unit 1501, an authentication data setting unit 1502 and a public key/secret key setting unit 1503, which are not included in the child node 102.

When the group key acquisition unit 1501 joins in the wireless mesh network including the root node 4100, the group key acquisition unit 1501 acquires a group key (encrypted using a root key A) from the root node 4100 via the communication unit 300. After acquiring an encrypted group key, the group key acquisition unit 1501 decrypts the encrypted group key, and acquires the group key. Furthermore, the group key acquisition unit 1501 receives a new group key (encrypted using a public key F) from the parent node 4101 via the communication unit 300. The group key acquisition unit 1502 decrypts an encrypted new group key using a secrete key G.

When the authentication data setting unit 1502 connects the wireless mesh network, the authentication data setting unit 1502 generates authentication data E using the public key F and a group key (before updating) received from the root node 4100.

The public key/secret key setting unit 1503 sets the secret key G and the public key F. The public key/secret key setting unit 1503 maintains the secret key G, and notifies the public key F with the authentication data E to the parent node 4101.

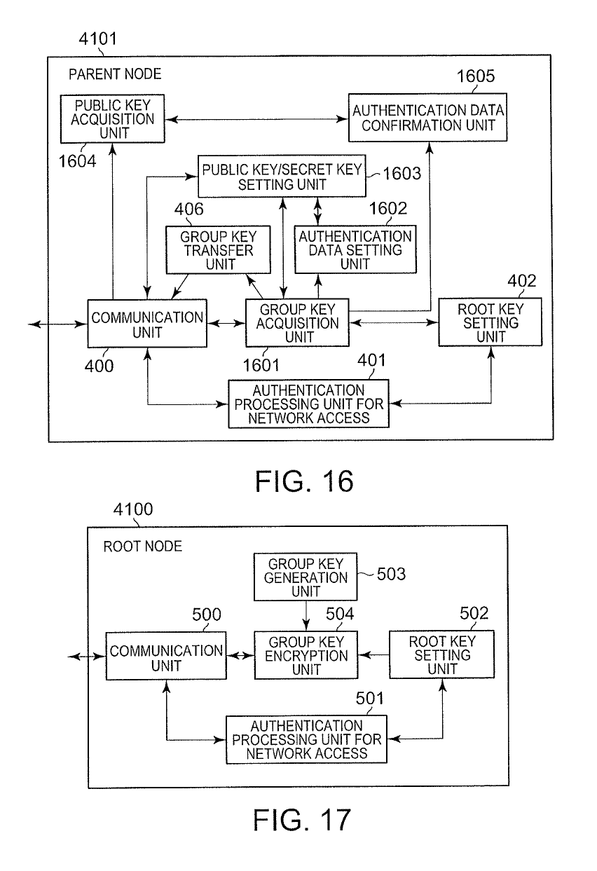

FIG. 16 is a block diagram of the parent node 4101 according to the fourth embodiment. The parent node 4101 has a function of the child node 4102. This feature is same as the first embodiment.

The parent node 4101 does not include the parent-child key setting unit 403, the group key acquisition unit 404 and the parent-child key acquisition unit 405, which are included in the parent node 101. However, the parent node 4101 includes a group key acquisition unit 1601, an authentication data setting unit 1602, a public key/secret key setting unit 1603, a public key acquisition unit 1604 and an authentication data confirmation unit 1605, which are not included in the parent node 101.

When the group key acquisition unit 1601 connects the wireless mesh network including the root node 4100, the group key acquisition unit 1601 acquires a group key (encrypted by a root key C) from the root node 4100 via the communication unit 400. After acquiring an encrypted group key, the group key acquisition unit 1601 decrypts the encrypted group key, and acquires the group key. Furthermore, the group key acquisition unit 1601 receives a new group key (encrypted using a public key H) from a node 104C (as a parent node of the parent node 4101) via the communication unit 400. The group key acquisition unit 1602 decrypts an encrypted new group key using a secrete key I corresponding to the public key H.

When the authentication data setting unit 1602 connects the wireless mesh network, the authentication data setting unit 1602 generates authentication data J using the public key H and a group key (before updating) received from the root node 4100.

The public key/secret key setting unit 1603 sets the secret key I and the public key H. The public key/secret key setting unit 1603 maintains the secret key I, and notifies the public key H with the authentication data J to a node 104C as a parent node of the parent node 4101.

The public key acquisition unit 1604 acquires the public key F (generated by the child node 4102) with the authentication data E. When the public key acquisition unit 1604 accepts a notification that the authentication data E is equal to authentication data (calculated) from the authentication data confirmation unit 1605, the public key acquisition unit 1604 decides that the public key F is a reliable key, and sets the public key F as a public key of the child node 4102.

The authentication data confirmation unit 1605 generates authentication data using the public key F and a group key (received from the root node 4100 when the parent node 4101 connects the wireless mesh network). By comparing the authentication data E to the authentication data generated, the authentication data confirmation unit 1605 confirms whether the authentication data E is equal to the authentication data generated. If the authentication data E is equal to the authentication data generated, the authentication data confirmation unit 1605 decides that the public key F is a key sent by the child node 4102, and notifies the purport to the public key acquisition unit 1604.

FIG. 17 is a block diagram of the root node 4100 according to the fourth embodiment. The root node 4100 does not include the parent-child key transfer unit 505, which is included in the root node 100.

Moreover, in the fourth embodiment, as mentioned-abode, authentication data is generated using the group key and the public key. However, the authentication data may be generated using at least the group key.

### The Fifth Embodiment

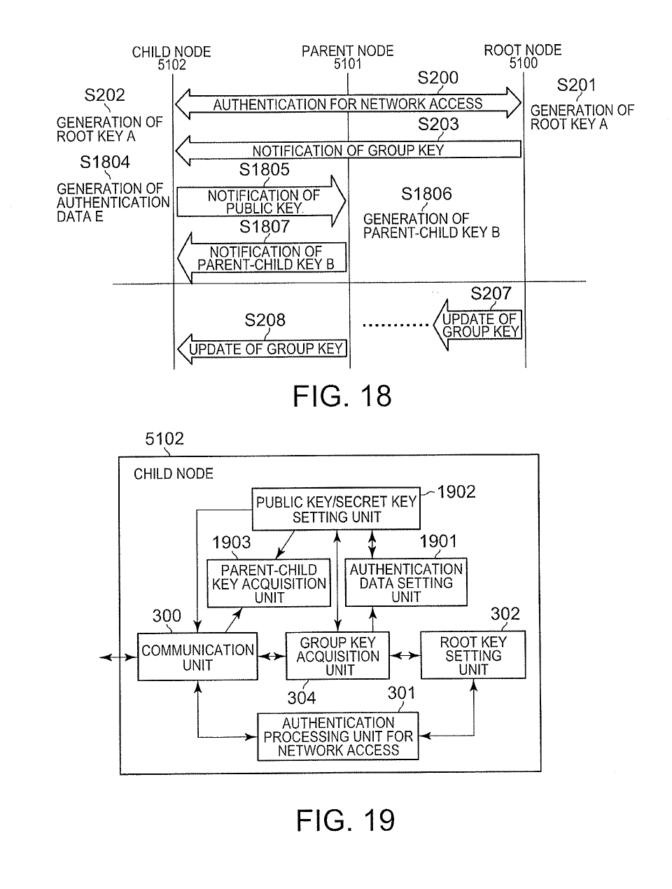

FIG. 18 is a sequence diagram showing operation of a system according to the fifth embodiment. As shown in FIG. 18, in the system of the fifth embodiment, a child node 5102 has a secret key, and a parent node 5101 has a public key received from the child node 5102. This feature and a process to exchange the public key are common to the fourth embodiment. On the other hand, in the system of the fifth embodiment, after acquiring the public key, the parent node 5101 generates a parent-child key B, encrypts the parent-child key B using the public key, and notifies an encrypted parent-child key B to the child node 5102. This feature is different from the fourth embodiment. Furthermore, the parent node 5101 encrypts a new group key (updated) using the parent-child key B, and notifies an encrypted new group key to the child node 5102. This feature is different from the fourth embodiment, but common to the first embodiment.

Next, operation of the system of the fifth embodiment is explained. Operation from S200 to S203 is same as that of the first embodiment. A step to generate authentication data E by the child node 5102 (S1804), and a step to notify the authentication data E and the public key F by the child node 5102 (S1805), are same as those of the fourth embodiment. Moreover, the child node 5102 maintains a secret key G corresponding to the public key F.

When the parent node 5101 receives the public key F, the parent node 5101 generates a parent-child key B (S1806). Then, the parent node 5101 encrypts the parent-child key B using the public key F, and notifies an encrypted parent-child key b to the child node 5102 (S1807). When the child node 5102 receives the encrypted parent-child key B, the child node 5102 decrypts the encrypted parent-child key B using the secret key G, and acquires the parent-child key B.

By above-mentioned operation, the parent node 5101 and the child node 5102 can share the parent-child key B as a common key.

Operation after this processing, i.e., steps to transfer the updated group key (notified by the root node 5100) to the parent node 5101 and the child node 5102 are same as S207 and S208 of the method explained in the first embodiment. Moreover, as to above-mentioned operation, same processing is executed in a node not shown in FIG. 1, as explained in the first embodiment.

By above-mentioned steps, when the parent-child key B is shared between the parent node 5101 and the child node 5102, processing load can be lowered. Furthermore, all nodes in the wireless mesh network (controlled by the root node 5100) can share the updated group key safely and effectively.

FIG. 19 is a block diagram of the child node 5102 according to the fifth embodiment. The child node 5102 does not include the parent-child key setting unit 303, which is included in the child node 102. However, the child node 5102 includes an authentication data setting unit 1901, a public key/secret key setting unit 1902 and a parent-child key acquisition unit 1903, which is not included in the child node 102.

When the authentication data setting unit 1901 generates authentication data E using the public key F and a group key (received from the root node 5100 when the child node 5102 connects the wireless mesh network).

The public key/secret key setting unit 1902 generates the secret key G and the public key F. The public key/secret key setting unit 1902 maintains the secret key G, and notifies the public key F with the authentication data E to the parent node 5101.

The parent-child key acquisition unit 1903 receives an encrypted parent-child key B sent from the parent node 5101. Then, the parent-child key acquisition unit 1903 decrypts the encrypted parent-child key B using the secret key G.

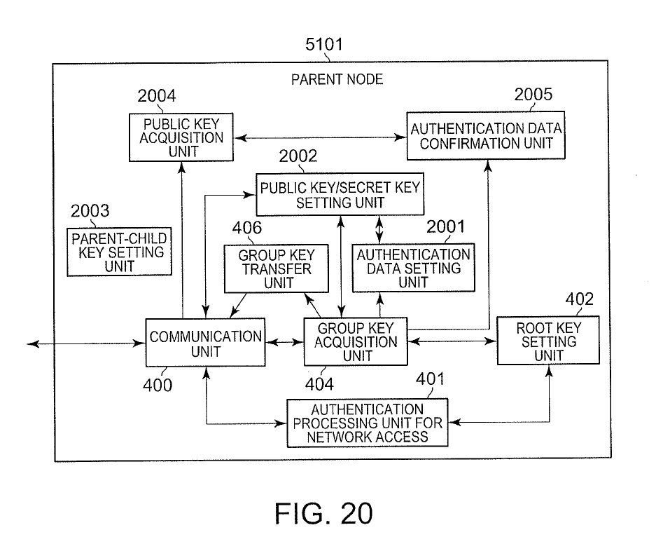

FIG. 20 is a block diagram of the parent node 5101 according to the fifth embodiment. The parent node 5101 has a function of the child node 5102. This feature is same as the first embodiment.

The parent node 5101 does not include the parent-child key setting unit 303, which is included in the parent node 101. However, the parent node 5101 includes an authentication data setting unit 2001, a public key/secret key setting unit 2002, a parent-child key setting unit 2003, a public key acquisition unit 2004 and an authentication data confirmation unit 2005, which are not included in the parent node 101.

When the authentication data setting unit 2001 generates authentication data J using the public key H and a group key (received from the root node 5100 when the parent node 5101 connects the wireless mesh network).

The public key/secret key setting unit 2002 generates the secret key I and the public key H. The public key/secret key setting unit 2002 maintains the secret key I, and notifies the public key H with the authentication data J to a node 104C as a parent node of the parent node 5101.

The parent-child key setting unit 2003 generates the parent-child key B. The parent-child key setting unit 2003 encrypts the parent-child key B using the public key F. Furthermore, the parent-child key setting unit 2003 sends an encrypted parent-child key B to the child node 5102 via the communication unit 400.

The public key acquisition unit 2004 acquires the public key F (generated by the child node 5102) with the authentication data E. When the public key acquisition unit 2004 accepts a notification that the authentication data E is equal to authentication data (calculated) from the authentication data confirmation unit 2005, the public key acquisition unit 2004 decides that the public key F is a reliable key, and sets the public key F as a public key of the child node 5102.

The authentication data confirmation unit 2005 generates authentication data using the public key F and a group key (received from the root node 5100 when the parent node 5101 connects the wireless mesh network). By comparing the authentication data E to the authentication data generated, the authentication data confirmation unit 2005 confirms whether the authentication data E is equal to the authentication data generated. If the authentication data E is equal to the authentication data generated, the authentication data confirmation unit 2005 decides that the public key F is a key sent by the child node 5102, and notifies the purport to the public key acquisition unit 2004.

Moreover, component of the root node 5100 of the fifth embodiment is same as component of the root node 4100 (Refer to FIG. 17).

As mentioned-above, as effect of at least one of the first, second, third, fourth and fifth embodiments, in the wireless mesh network, processing load to exchange the key (necessary for encrypting the group key) can be lowered.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A node in a wireless mesh network including a plurality of nodes of which one is a root node and two nodes hierarchically adjacent have a parent-child relationship, the node comprising:
an authentication processing unit configured to, when the node joins in the wireless mesh network, execute an authentication for network access with the root node;
a root key setting unit configured to generate a root key as a common key between the root node and the node;
a parent-child key setting unit configured to generate a parent-child key as a common key between a parent node and the node, to encrypt the parent-child key using the root key, and to send the parent-child key encrypted to the root node, the parent node and the node having the parent-child relationship; and
a group key acquisition unit configured to receive a group key encrypted using the parent-child key from the parent node, and to decrypt the group key using the parent-child key.

2. A node in a wireless mesh network including a plurality of nodes of which one is a root node and two nodes hierarchically adjacent have a parent-child relationship, the node comprising:
an authentication processing unit configured to, when the node joins in the wireless mesh network, execute an authentication for network access with the root node;
a root key setting unit configured to generate a root key as a common key between the root node and the node;
a parent-child key acquisition unit configured to receive a parent-child key encrypted using the root key from the root node, and to decrypt the parent-child key using the root key; and
a group key transfer unit configured to encrypt a group key using the parent-child key, and to send the group key encrypted to a child node, the node and the child node having the parent-child relationship.

3. The node according to claim 2,
wherein the parent-child key are sent from the root node to the node and the child node respectively.

4. A root node in a wireless mesh network including a plurality of nodes of which two nodes hierarchically adjacent have a parent-child relationship, the root node comprising:
an authentication processing unit configured to, when a new node joins in the wireless mesh network, execute an authentication for network access with the new node;
a root key setting unit configured to generate a first root key as a common key between the root node and a first node in the wireless mesh network, and to generate a second root key as a common key between the root node and a second node in the wireless mesh network, the second node and the first node having the parent-child relationship;
a parent-child key transfer unit configured to receive a parent-child key encrypted using the first root key from the first node, to decrypt the parent-child key using the first root key, to encrypt the parent-child key using the second root key, and to send the parent-child key encrypted to the second node; and
a group key encryption unit configured to encrypt a group key using the parent-child key, and to send the group key encrypted to the second node.

5. A node in a wireless mesh network including a plurality of nodes of which one is a root node and two nodes hierarchically adjacent have a parent-child relationship, the node comprising:
an authentication processing unit configured to, when the node joins in the wireless mesh network, execute an authentication for network access with the root node;
a root key setting unit configured to generate a root key as a common key between the root node and the node;
a parent-child key setting unit configured to receive a parent-child key encrypted using the root key from the root node, to decrypt the parent-child key using the root key; and
a group key acquisition unit configured to receive a group key encrypted using the parent-child key from a parent node, and to decrypt the group key using the parent-child key, the parent node and the node having the parent-child relationship.

6. The node according to claim 5,
wherein the parent-child key is sent from the parent node via the root node.

7. A node in a wireless mesh network including a plurality of nodes of which one is a root node and two nodes hierarchically adjacent have a parent-child relationship, the node comprising:
an authentication processing unit configured to, when the node joins in the wireless mesh network, execute an authentication for network access with the root node;
a root key setting unit configured to generate a root key as a common key between the root node and the node;
a parent-child key acquisition unit configured to receive a parent-child key encrypted using the root key from the root node, and to decrypt the parent-child key using the root key; and
a group key transfer unit configured to encrypt a group key using the parent-child key, and to send the group key encrypted to a child node, the node and the child node having the parent-child relationship.

8. A root node in a wireless mesh network including a plurality of nodes of which two nodes hierarchically adjacent have a parent-child relationship, the root node comprising:
an authentication processing unit configured to, when a new node joins in the wireless mesh network, execute an authentication for network access with the new node;
a root key setting unit configured to generate a first root key as a common key between the root node and a first node in the wireless mesh network, and to generate a second root key as a common key between the root node and a second node in the wireless mesh network, the second node and the first node having the parent-child relationship;
a parent-child key setting unit configured to generate a parent-child key as a common key between the first node and the second node, to send the parent-child key encrypted using the first root key to the first node, and to send the parent-child key encrypted using the second root key to the second node; and
a group key encryption unit configured to encrypt a group key using the parent-child key, and to send the group key encrypted to the second node.

9. A node in a wireless mesh network including a plurality of nodes of which one is a root node and two nodes hierarchically adjacent have a parent-child relationship, the node comprising:
an authentication processing unit configured to, when the node joins in the wireless mesh network, execute an authentication for network access with the root node;
a root key setting unit configured to generate a root key as a common key between the root node and the node;
a parent-child key setting unit configured to generate a parent-child key as a common key between the node and a child node, to encrypt the parent-child key using the root key, and to send the parent-child key encrypted to the root node, the node and the child node having the parent-child relationship; and
a group key transfer unit configured to encrypt a group key using the parent-child key, and to send the group key encrypted to the child node.

10. A root node in a wireless mesh network including a plurality of nodes of which two nodes hierarchically adjacent have a parent-child relationship, the root node comprising:
an authentication processing unit configured to, when a new node joins in the wireless mesh network, execute an authentication for network access with the new node;
a root key setting unit configured to generate a first root key as a common key between the root node and a first node in the wireless mesh network, and to generate a second root key as a common key between the root node and a second node in the wireless mesh network, the second node and the first node having the parent-child relationship; and
a parent-child key transfer unit configured to receive a parent-child key encrypted using the second root key from the second node, to decrypt the parent-child key using the second root key, to encrypt the parent-child key using the first root key, and to send the parent-child key encrypted to the first node.

11. A node in a wireless mesh network including a plurality of nodes of which one is a root node and two nodes hierarchically adjacent have a parent-child relationship, the node comprising:
an authentication processing unit configured to, when the node joins in the wireless mesh network, execute an authentication for network access with the root node;
a root key setting unit configured to generate a root key as a common key between the root node and the node;
a group key acquisition unit configured to, when the node joins in the wireless mesh network, receive a first group key encrypted using the root key from the root node;
an authentication data setting unit configured to generate authentication data using the first group key; and
a public key/secret key setting unit configured to generate a public key and a secret key, and to send the public key and the authentication data to a parent node, the parent node and the node having the parent-child relationship;
wherein the group key acquisition unit receives a second group key encrypted using the public key from the parent node, and decrypts the second group key using the secret key.

12. A node in a wireless mesh network including a plurality of nodes of which one is a root node and two nodes hierarchically adjacent have a parent-child relationship, the node comprising:
an authentication processing unit configured to, when the node joins in the wireless mesh network, execute an authentication for network access with the root node;
a root key setting unit configured to generate a root key as a common key between the root node and the node;
a group key acquisition unit configured to, when the node joins in the wireless mesh network, receive a first group key encrypted using the root key from the root node;
an authentication data setting unit configured to generate authentication data using the first group key;
a public key/secret key setting unit configured to generate a public key and a secret key, and to send the public key and the authentication data to a parent node, the parent node and the node having the parent-child relationship; and
a parent-child key acquisition unit configured to receive a parent-child key encrypted using the public key from the parent node, and to decrypt the parent-child key using the secret key;
wherein the group key acquisition unit receives a second group key encrypted using the parent-child key from the parent node, and decrypts the second group key using the parent-child key.

13. A computer readable medium for causing a computer to perform a method for controlling a node in a wireless mesh network including a plurality of nodes of which one is a root node and two nodes hierarchically adjacent have a parent-child relationship, the method comprising:
when the node joins in the wireless mesh network, executing an authentication for network access with the root node;
generating a root key as a common key between the root node and the node;
generating a parent-child key as a common key between a parent node and the node, the parent node and the node having the parent-child relationship;
encrypting the parent-child key using the root key;
sending the parent-child key encrypted to the root node;
receiving a group key encrypted using the parent-child key from the parent node; and
decrypting the group key using the parent-child key.

14. A computer readable medium for causing a computer to perform a method for controlling a node in a wireless mesh network including a plurality of nodes of which one is a root node and two nodes hierarchically adjacent have a parent-child relationship, the method comprising:
when the node joins in the wireless mesh network, executing an authentication for network access with the root node;
generating a root key as a common key between the root node and the node;
receiving a parent-child key encrypted using the root key from the root node;
decrypting the parent-child key using the root key;
receiving a group key encrypted using the parent-child key from a parent node, the parent node and the node having the parent-child relationship; and
decrypting the group key using the parent-child key.

15. A computer readable medium for causing a computer to perform a method for controlling a root node in a wireless mesh network including a plurality of nodes of which two nodes hierarchically adjacent have a parent-child relationship, the method comprising:
when a new node joins in the wireless mesh network, executing an authentication for network access with the new node;
generating a first root key as a common key between the root node and a first node in the wireless mesh network;
generating a second root key as a common key between the root node and a second node in the wireless mesh network, the second node and the first node having the parent-child relationship;
generating a parent-child key as a common key between the first node and the second node;
sending the parent-child key encrypted using the first root key to the first node;
sending the parent-child key encrypted using the second root key to the second node;
encrypting a group key using the parent-child key; and
sending the group key encrypted to the second node.

16. A computer readable medium for causing a computer to perform a method for controlling a node in a wireless mesh network including a plurality of nodes of which one is a root node and two nodes hierarchically adjacent have a parent-child relationship, the method comprising:
when the node joins in the wireless mesh network, executing an authentication for network access with the root node;
generating a root key as a common key between the root node and the node;
when the node joins in the wireless mesh network, receiving a first group key encrypted using the root key from the root node;
generating authentication data using the first group key;
generating a public key and a secret key;
sending the public key and the authentication data to a parent node, the parent node and the node having the parent-child relationship;
receiving a parent-child key encrypted using the public key from the parent node; and
decrypting the parent-child key using the secret key;
wherein the receiving a first group key includes
receiving a second group key encrypted using the parent-child key from the parent node, and
decrypting the second group key using the parent-child key.
